(19) United States
(12) Patent Application Publication
(10) Pub. No.: US 2009/0291306 A1
(43) Pub. Date: Nov. 26, 2009

(54) METHOD FOR CUTTING OF OPEN-CELL FOAMS BASED ON AMINOPLASTS AND METHOD FOR THE PRODUCTION OF FLAKES OR PARTICLES

(76) Inventor: Hans-Jurgen Quadbeck-Seeger, Bad Durkheim (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/373,168

(22) PCT Filed: Jul. 30, 2007
(86) PCT No.: PCT/EP07/56686

§ 371 Date: Jan. 9, 2009

(30) Foreign Application Priority Data
Jul. 12, 2006 (EP) 06117052.8

(51) Int. Cl. B32B 27/42; C08G 12/12

(52) U.S. Cl. 428/402; 521/188

(57) ABSTRACT

An improved method of cutting open-celled foams based on aminoplastics and of producing flocks or finely divided particles, and also their use as cleaners and polishing media.

The invention relates to an improved method of cutting open-celled foams based on aminoplastics and of producing flocks or finely divided particles, and also their use.

Open-celled foams based on a melamine/formaldehyde condensation product are known for various thermal and acoustic insulation applications in buildings and vehicles and also as insulating and shock-damping packaging material.

It is known that particles or flocks of open-celled foams based on melamine-formaldehyde resins as recycled material can be adhesively bonded together to form new foam mats (EP-B 451 535). A further possibility is use as material for improving soil. However, dust is formed when the open-celled foam is cut dry.

In abrasive and polishing pastes, abrasive particles having a small particle size and a high hardness are frequently used, but these lead to tiny scratches on the surface to be polished during polishing. The German utility model DE 298 08 991 U1 proposes using a polishing paste in which the abrasives are dispersed in a carrier substance and whose viscosity decreases under the conditions of polishing for polishing plastic surfaces.

DE-A 31 02 567 describes an abrasive and polishing paste for polishing metal surfaces, in which uniformly distributed powder particles whose hardness is between the hardness of the abrasive particles and the hardness of the melt of the paste have been introduced into the melt. As powder particles, mention is made of metal particles such as copper powder, aluminum powder, zinc powder, brass powder or the like.

It was an object of the invention to remedy the disadvantages mentioned and to discover a simple and dust-free method of cutting open-celled foams based on aminoplastics and also a method of producing flocks or finely divided particles.

We have accordingly found a method of cutting open-celled foams based on an aminoplastic, which comprises impregnating the open-celled foam with a liquid and cutting the impregnated foam. In this way, it is possible to shape, for example, by means of a punch, even complicated contours in a dust-free manner.

Furthermore, we have found a method of producing finely divided particles, which comprises impregnating an open-celled foam based on an aminoplastic with a liquid and comminuting the impregnated foam to form particles having a mean diameter in the range from 0.1 to 1000 μm, preferably in the range from 50 to 500 μm.

As open-celled foams, preference is given to using elastic foams based on a melamine-formaldehyde condensation product having a specific density of from 5 to 100 g/l, in particular from 8 to 20 g/l. The cell count is usually in the range from 50 to 300 cells/25 mm. The tensile strength is preferably in the range from 100 to 150 kPa and the extension at break is in the range from 8 to 20%.

To produce the foam, it is possible, as described in EP-A 071 672 or EP-A 037 470, to foam and cure a highly concentrated solution or dispersion of a melamine-formaldehyde precondensate which comprises blowing agent by means of hot air, steam or microwave radiation. Such foams are commercially available under the name Basotect® from BASF Aktiengesellschaft.

The molar ratio of melamine/formaldehyde is generally in the range from 1:1 to 1:5. To produce foams which are particularly low in formaldehyde, the molar ratio is selected in the range from 1:1.3 to 1:1.8 and a precondensate which is free of sulfite groups is used, as described in, for example, WO 01/94436.

According to the invention, the open-celled foam is impregnated with a liquid, for example alcohols, ketones, liquid hydrocarbons or water, before cutting or comminution. Preference is given to using water.

Comminution can be carried out by means of customary comminuting machines which have rotating knifes or crushing parts. Suitable comminuting machines are, for example, mills such as bore mills or Ultraturrax, extruders.

Depending on the type of comminuting machine or the speed of rotation of the knives, finely divided particles (powder) or pieces resembling absorbent cotton (flocks) can be obtained. A piece of foam impregnated with water or alcohol can in this way be processed particularly simply and in a dust-free manner to produce an aminoplastic particle suspension. If desired, the suspension can subsequently be filtered or centrifuged and the powder obtained can subsequently be dried.

The dried powder or the flocks can, for example, be added as aggregate to polymer melts in an extruder or else can be used as material for improving soil and regulating moisture in gardening or in agriculture.

Apart from the possibility of reusing production scrap or reject material in the production or further processing of open-celled foams, the flocks or finely divided powders which can be obtained by the method of the invention are suitable, in particular, as cleaning or polishing materials for surfaces.

The finely divided powders can here be applied directly either in dried form or preferably directly as aqueous suspension to sponges or nonwovens and woven fabrics or be applied as coatings together with film-forming polymers. Particular preference is given to foams, nonwovens or woven fabrics comprising melamine resins. When a nonwoven or woven fabric is used, the pressure can be controlled easily and the cleaning action can be matched to requirements.

Since the open-celled foams are flame resistant, the flocks and particles of the invention are, in combination with water, suitable as an excellent fire extinguishing medium.

Furthermore, organic substances, for example oil in the case of a spill at sea, can be absorbed quickly and easily from the surface of the water by means of the flocks of the invention and disposed of by collecting or pumping away of the impregnated flocks.

The invention further provides a polishing paste which comprises the finely divided aminoplastic particles which can be obtained by the above-described method as abrasive. Since the abrasive has an organic basis, it has a lower hardness than the abrasive particles customarily used, e.g. diamond, α-alumina or silicates.

It can therefore be used in polishing pastes either alone or, if appropriate, together with further customary strongly abrasive abrasives such as aluminum oxides, magnesium oxides, chromium oxides, tin(IV) oxides, iron oxides, silicon carbide, kieselguhr, diamond dust, cerium oxides and/or zirconium oxides.

Suitable carrier substances for the polishing paste are, for example, water, alcohols, polyethylene glycol or waxes. The carrier substance for the polishing paste is preferably used beforehand as liquid for impregnating the open-celled foam before comminution.

Further customary additives such as suspension stabilizers, antisedimentation agents, bentonites or fragrances can be added to the polishing medium or the polishing paste.

The polishing medium or polishing paste is suitable for gentle cleaning and polishing of plastics, glasses, automobile windows, coated surfaces, metals, magnetic data carriers, electronic circuits, silicon wafers or teeth, tooth prostheses, tooth fillings or artificial teeth.

The mechanical polishing can be effected by gently pressing the workpiece concerned, e.g. comprising metal, glass, wood, plastic or leather, onto horizontal disks which are driven by a motor and covered with a woolen cloth or velvet and are painted with the polishing medium or polishing paste according to the invention.

### EXAMPLES

### Example 1

A 2 cm×4 cm×10 cm piece of an open-celled melamine-formaldehyde foam having a density of 15 g/m³ (Basotect® from BASF Aktiengesellschaft) was impregnated with water and comminuted for 5 minutes in a domestic mixer (Moulinex). This gave a suspension having a solids content of about 2% by weight.

### Example 2

The suspension from Example 1 was admixed successively with further, dry Basotect® pieces and comminuted in a domestic mixer until the solids content was 15% by weight.

The suspension was subsequently poured onto a cleaning cloth and a soiled table surface was cleaned by means of gentle pressure.

### Example 3

A plurality of 1 cm×1 cm×1 cm cubes of an open-celled melamine-formaldehyde foam having a density of 15 g/m³ (Basotect® from BASF Aktiengesellschaft) was impregnated with water and comminuted by means of a domestic mixer (Zauberstag) to give flocks. The flocks were subsequently dried in a microwave oven.

1. (canceled)

2. A method of producing particles, which comprises impregnating an open-celled foam based on an aminoplastic with a liquid and comminuting the impregnated foam to form particles having a mean diameter in the range from 0.1 to 1000 μm.

3. The method according to claim 1, wherein an open-celled melamine-formaldehyde resin foam is used.

4. The method according to any of claims 1, wherein the open-celled foam has a specific density in the range from 5 to 100 g/l.

5. The method according to claim 1, wherein the open-celled foam has been produced from a melamine-formaldehyde condensation product having a molar ratio of melamine/formaldehyde in the range from 1:1 to 1:5.

6. A particle or flock obtainable by the method of claim 2.

7. (canceled)

8. A polishing paste comprising particles according to claim 6.

9. (canceled)

10. (canceled)

11. The method according to claim 1, wherein water or alcohol are used as a liquid.

12. The method according to claim 2, wherein an open-celled melamine-formaldehyde resin foam is used.

13. The method according to claim 2, wherein the open-celled foam has a specific density in the range from 5 to 100 g/l.

14. The method according to claim 3, wherein the open-celled foam has a specific density in the range from 5 to 100 g/l.

15. The method according to claim 2, wherein the open-celled foam has been produced from a melamine-formaldehyde condensation product having a molar ratio of melamine/formaldehyde in the range from 1:1 to 1:5.

16. A particle or flock obtainable by the method of claim 3.

17. A particle or flock obtainable by the method of claim 4.

18. A particle or flock obtainable by the method of claim 5.
